(19) United States
(12) Patent Application Publication
(10) Pub. No.: US 2006/0137871 A1
(43) Pub. Date: Jun. 29, 2006

(54) Air conditioning method

(75) Inventor: Rolf Roehm, Jettingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/537,256

(22) PCT Filed: Nov. 3, 2003
(86) PCT No.: PCT/EP03/12196

§ 371 Date: Nov. 14, 2005

(30) Foreign Application Priority Data
Dec. 2, 2002 (DE) 10256409.4

(51) Int. Cl. B60H 1/00; G05D 23/00

(52) U.S. Cl. 165/203; 165/204; 165/291

(57) ABSTRACT

The present invention discloses a climate control method, in which a distinction is drawn between climate control corresponding to a conventional method, and a modified climate control process. The modified climate control according to the invention is used when an occupant wishes to have less cooling, and thus raises the nominal internal temperature, after being cooled down to the physical limit, that is to say the minimum blowing-in temperature, before the vaporizer ices up, for example when the outside temperatures are very high. Since, in a situation such as this, the nominal blowing-in temperature both for the previous nominal internal area temperature and for the new, higher nominal internal area temperature is still well below the physically achievable limit, a second nominal blowing-in temperature is now calculated, in which the nominal internal area temperature change and the outside temperature are taken into account. The actual blowing-in temperature is controlled as a function of which of the two nominal blowing-in temperatures is the maximum. In this way, it is possible to achieve a direct response to the increase in the nominal internal area temperature even if the conventionally calculated nominal blowing-in temperature were still below the physically achievable blowing-in temperature.

### BACKGROUND AND SUMMARY OF THE INVENTION

The invention relates to a climate control method.

DE 43 31 142 C2 discloses a method by means of which the internal area temperature is always regulated to the nominal internal area temperature setting irrespective of the respectively prevailing temperature of the external area from which, for example, the internal area medium is taken in the case of a motor vehicle air-conditioning system, by appropriate adjustment of the temperature of the flowing-in medium. If required, the medium is cooled-down [and/]or heated for this purpose before it flows into the vehicle.

In the case of vehicles with temperature and/or fan control, it is likewise known for the blowing-in temperature of the air-conditioning system to be calculated as a function of the outside temperature, the internal area temperature and a nominal internal area temperature setting.

However, the problem with climate control methods such as these is that, when the outside temperatures are very high, for example between 35° C. and 55° C. and/or there is additional solar radiation, a very low nominal blowing air temperature, for example −30° C. to −60° C., is calculated. For physical reasons, specifically icing up of the vaporizer, the lowest blowing-in temperature is, however, about 3° C. to 5° C. If an occupant wishes to be warmer, and changes the nominal value from 22° C. to, for example, 24° C., the calculation of the nominal blowing-air temperature is increased only to about −10° C. to −20° C. Since, however, the blowing-out temperature is physically limited to 3° C. to 5° C., and a blowing air nominal temperature of down to −60° C. is calculated, the nominal value change is not detectable for the occupant. The nominal value must be set even higher depending on the values of the control parameters, that is to say the outside temperature, the nominal value, the influence of the sun (the solar radiation) and the internal area temperature until a positive blowing air temperature is calculated by the climate control calculation.

One object of the present invention is to develop a climate control method such that the climate control responds immediately to a change in a nominal value even when the outside temperatures are very high and/or the solar radiation is strong.

According to the invention, this object is achieved by a climate control method.

The control system according to the invention makes it possible to achieve a detectable reaction to a manual action. In other words, the nominal internal area temperature is increased even though a nominal blowing-in temperature calculated for this nominal internal area temperature, in the same way as a previous nominal blowing-in temperature for a lower nominal internal area temperature, is not feasible owing to the physical limits and, Conventionally, the lower limit value of the blowing-in temperature was used as standard in both cases.

In particular, the method according to the invention can also and in particular be used for multiple zone air-conditioning systems since more comfort for the individual seat positions can now be achieved in this case, since it is possible to adapt the blowing-in temperature separately for each area.

### BRIEF DESCRIPTION OF THE DRAWINGS

These and further objects, features and advantages of the present invention will become clear from the following description of one preferred exemplary embodiment, in conjunction with the drawing, in which:

FIG. 1 shows a flowchart of the climate control method according to the invention.

### DETAILED DESCRIPTION OF THE DRAWINGS

Conventional climate control methods are subject to the problem that the blowing-in temperature T_{blowing-in-min} cannot be below 1° C. to 3° C. owing to the physical limit of the vaporizer icing up, even though a calculated nominal blowing-in temperature would be considerably lower. Because of this, it is impossible, if the outside temperatures are high and/or the solar radiation is severe; to provide a nominal blowing-in temperature T_{blowing-in-nom} which is calculated as a function of the outside temperature T_{A}, the actual internal area temperature T_{I} and a nominal internal area temperature setting T_{Inom}. In a situation such as this, even in the event of a readjustment by increasing the nominal internal area temperature, it is possible for the nominal blowing-in temperature T_{blowing-in-nom} calculated using the new nominal internal area temperature T_{Inom-new} still to be well below the achievable value, as well. The occupant therefore cannot detect any control change, so that he requires several manual readjustment processes until he is provided with a blowing-in temperature T_{blowing-in} which is comfortable for him. This is where the air-conditioning method according to the invention comes into play, in order to provide a modified form of climate control in this case, with which this problem no longer occurs.

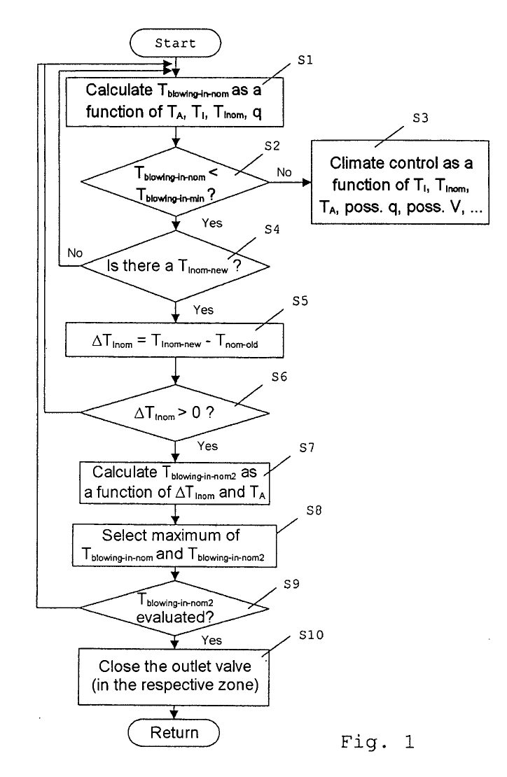

The climate control method according to the invention will now be described in the following text with reference to FIG. 1. This method allows the problem described above to be overcome and allows a comfortable control for the occupant or occupants.

In the climate control method according to the invention, the conventional method is first of all used in a first step S1 to calculate the nominal blowing-in temperature T_{blowing-in-nom} as a function of the outside temperature T_{A}, the actual internal area temperature T_{I} and the nominal internal area temperature T_{I nom}. Then, in a step S2, the calculation result, that is to say the nominal blowing-in temperature T_{blowing-in-nom} is compared with the minimum physically achievable blowing-in temperature T_{blowing-in-min}. If it is found in the step S2 that the calculated nominal blowing-in temperature T_{blowing-in-nom} is higher than the minimum blowing-in temperature T_{blowing-in-min}, conventional climate control is carried out in step S3, as a function of the actual internal area temperature T_{I}, the nominal internal area temperature T_{Inom}, the outside temperature T_{A} and, if appropriate, the solar radiation q, and the speed v, etc. If, in contrast, the calculated nominal blowing-in temperature T_{blowing-in-nom} in step S2 is below the minimum blowing-in temperature T_{blowing-in-min}, a check is carried out in step S4 to determine whether there is a new nominal internal area value T_{Inom-new}. If there is no such value, an internal area temperature normal value, for example of 22° C., is used instead of this, and the process returns to step S1.

If there is a new nominal internal area value T_{Inom-new}, a nominal internal area temperature change Δt_{Inom} is then calculated in step S5 from the difference between T_{Inom-new} and T_{Inom-old}. A check is then carried out in step S6 to determine whether the nominal internal area temperature change ΔT_{Inom} is greater than zero, that is to say whether the manual action should result in a temperature increase. If there is no temperature increase, that is to say the nominal internal temperature change ΔT_{Inom} is present, the process returns to step S1, otherwise it progresses to step S7. In step S7, a second nominal blowing-in temperature T_{blowing-in-nom2} is now calculated as a function of the nominal internal area temperature change ΔT_{Inom} and the outside temperature T_{A}. The calculation is carried out with reference to empirical values determined by measurements for optimum control. A maximum of the nominal blowing-in temperature T_{blowing-in-nom} and the second nominal blowing-in temperature is then determined is step S8. A check is then carried out in step S9 to determine whether the second nominal blowing-in temperature T_{blowing-in-nom2} has been chosen as a maximum. If this is the case, the outlet valve, in the case of several zones, the outlet valve in the respective zone, is closed in step S10. Otherwise the process returns directly to step S1.

In one preferred development of the invention, the climate control method according to the invention is used for multiple zone air-conditioning systems in such a way that the climate control process described above with reference to FIG. 1 is carried out for each of the temperature preselection devices for the various zones as soon as the calculated nominal blowing-in temperature T_{blowing-in-nom} is below the physically minimum possible blowing-in temperature T_{blowing-in-min}. This allows very comfortable climate control to be carried out separately for each separately air-conditioned vehicle area, so that occupants located in a different area are not also affected by the climate control, so that their comfort is not adversely affected either.

1-5. (canceled)

6. A climate control method as a follow-up control system, in which system an internal area temperature is controlled taking into account an external temperature, by determining and adjusting a blowing-in temperature of the flowing in a medium flowing from an exterior to an interior, to a nominal internal area temperature which is stored and is set by an occupant, with the medium first of all being cooled down and/or heated before flowing in, as a function of the external temperature, the method comprising the steps:
storing the nominal internal area temperature value in a first memory,
(S1) detecting the external temperature an actual internal area temperature and of the nominal internal area temperature setting, and calculating a first nominal blowing-in temperature as a function of the external temperature, of the actual internal area temperature and of the nominal internal area temperature setting,
(S2) comparing the calculated first nominal blowing-in temperature with a predetermined minimum blowing-in temperature, which is above an icing-up temperature of an air-conditioning system,
(S3) if the first nominal blowing-in temperature is above the predetermined minimum blowing-in temperature, carrying out climate control as
a function of the actual internal area temperature, the nominal internal area temperature, the external temperature by controlling the blowing-in temperature,
(S4) if the first nominal blowing-in temperature is below the minimum blowing-in temperature, determining whether the stored nominal internal area temperature setting and the stored nominal internal area temperature value in the first memory are the same, whereas if the setting is the same as the value, return to S1,
(S5) if the setting is different from the value, determining a nominal internal temperature change from the difference between the stored nominal internal area temperature setting and the stored nominal internal area temperature value in the first memory,
(S6) if the nominal internal area temperature change has a value less than or equal to zero, returning to S1, TP (S7) if the nominal internal area temperature change has a value greater than zero, calculating a second nominal internal area temperature as a function of the nominal internal area temperature change and of the external temperature in such a way that this results in an increase in the nominal blowing-in temperature,
(S8) comparing the first nominal blowing-in temperature and the second nominal blowing-in temperature, and selecting the larger of the first nominal blowing-in temperature and the second nominal blowing-in temperature,
(S9) if the second nominal blowing-in temperature, is not selected, return to S1,
(S10), if the second nominal blowing-in temperature is selected, closing an outlet valve for a predetermined time period, and then return to S1.

7. The climate control method as claimed in claim 6, comprising
calculating the second nominal blowing-in temperature as a function of the external temperature and of the nominal internal area temperature change on the basis of reference curves determined by measurement.

8. The climate control method as claimed in claim 6,
wherein the nominal internal area temperature value in the first memory is the last stored nominal internal area temperature as set by the occupant.

9. The climate control method as claimed in claim 7,
wherein the nominal internal area temperature value in the first memory is the last stored nominal internal area temperature as set by the occupant.

10. The climate control method as claimed in claim 6,
wherein the nominal internal area temperature value in the first memory is 22° C.

11. The climate control method as claimed in claim 7,
wherein the nominal internal area temperature value in the first memory is 22° C.

12. The climate control method as claimed in claim 8,
wherein the nominal internal area temperature value in the first memory is 22° C.

13. The climate control method as claimed in claim 9,
wherein the nominal internal area temperature value in the first memory is 22° C.

14. The climate control method as claimed in claim 6,
wherein the method is carried out separately in a multiple zone air-conditioning system for each separately air-conditioned vehicle area.

15. The climate control method as claimed in claim 7,
wherein the method is carried out separately in a multiple zone air-conditioning system for each separately air-conditioned vehicle area.

16. The climate control method as claimed in claim 8,
wherein the method is carried out separately in a multiple zone air-conditioning system for each separately air-conditioned vehicle area.

17. The climate control method as claimed in claim 9,
wherein the method is carried out separately in a multiple zone air-conditioning system for each separately air-conditioned vehicle area.

18. The climate control method as claimed in claim 10,
wherein the method is carried out separately in a multiple zone air-conditioning system for each separately air-conditioned vehicle area.

19. The climate control method as claimed in claim 6,
wherein the method is carried out separately in a multiple zone air-conditioning system for each separately air-conditioned vehicle area.

20. The climate control method as claimed in claim 7,
wherein the method is carried out separately in a multiple zone air-conditioning system for each separately air-conditioned vehicle area.

21. The climate control method as claimed in claim 8,
wherein the method is carried out separately in a multiple zone air-conditioning system for each separately air-conditioned vehicle area.

22. The climate control method as claimed in claim 6, further comprising, if the first nominal blowing in temperature is above the predetermined minimum blowing-in temperature, carrying out climate control as a function of, additionally, at least one of solar radiation and vehicle speed by controlling, additionally, an air mass flow.
